(19) United States
(12) Patent Application Publication
(10) Pub. No.: US 2026/0236672 A1
(43) Pub. Date: Aug. 13, 2026

(54) METHOD, APPARATUS, ELECTRONIC DEVICE AND STORAGE MEDIUM FOR DOCUMENT CREATION

(71) Applicant: Beijing Zitiao Network Technology Co., Ltd., Beijing (CN)

(72) Inventors: Zihuan Lin, Beijing (CN); Ziheng Wang, Beijing (CN); Zhuozhen Wen, Beijing (CN); Huanxu Zhang, Beijing (CN)

(21) Appl. No.: 19/155,937

(22) PCT Filed: Feb. 5, 2024
(86) PCT No.: PCT/CN2024/076171

§ 371 Date: Aug. 12, 2025

(30) Foreign Application Priority Data
Feb. 15, 2023 (CN) 202310147200.9

(51) Int. Cl. G06F 40/177; G06F 3/0483; G06F 40/186

(52) U.S. Cl. CPC G06F 40/177; G06F 40/186; G06F 3/0483

(57) ABSTRACT

The method, apparatus, electronic device and storage medium for document creation provided in the disclosure include: displaying an adding panel in response to receiving a page adding operation in a first page of a table, the adding panel including a target document type being a type other than a table; generating a second page in the table in response to a first selection operation on the target document type, the second page displaying a document corresponding to the target document type. According to the disclosure, the adding creation option of the corresponding document is added in the adding directory of the first page of the table, the user may insert the document in the first page of the table by triggering the option, so that the document and the document editing tool are added in the first page and the table editing tool of the table.

This application claims priority to Chinese Patent Application No. 202310147200.9, filed on Feb. 15, 2023, and entitled “METHOD, APPARATUS, ELECTRONIC DEVICE AND STORAGE MEDIUM FOR DOCUMENT CREATION”, the disclosure of which is incorporated herein by reference in its entirety.

### FIELD

This application relates to the field of computer technology, and more particularly, to a method, apparatus, electronic device and storage medium for document creation.

### BACKGROUND

A spreadsheet, also known as an electronic data sheet, is various cells composed of a series of rows and columns. Values, calculations, texts and the like may be stored in the cells. A spreadsheet is typically created by a spreadsheet workbook, in which a plurality of tabs may be included, each corresponding to a spreadsheet.

However, with the increase of user demands for table use, the fact that the current spreadsheet workbook can only add the form of the spreadsheet can no longer meet the user demand, the representation pattern is rather single, and the user experience is poor.

### SUMMARY

In view of this, this application provides a method, apparatus, electronic device and storage medium for document creation, to allow a document to be added in a first page of a table, thereby enriching a text expression capability of the table, improving an overall representation pattern of a table editing tool and improving user experience.

Based on the foregoing objective, this application provides a method of document creation, including:
displaying an adding panel in response to receiving a page adding operation in a first page of a table, the adding panel including a target document type, the target document type being a type other than a table;
generating a second page in the table in response to a first selection operation on the target document type, the second page displaying a document corresponding to the target document type.

Based on the same concept, the present disclosure further provides a apparatus for document creation, including:
a response module configured to display an adding panel in response to receiving a page adding operation in a first page of a table, the adding panel including a target document type, the target document type being a type other than a table; and
a creation module configured to generate a second page in the table in response to a first selection operation on the target document type, the second page displaying a document corresponding to the target document type.

Based on the same concept, this application further provides an electronic device, including a memory, a processor, and a computer program stored in the memory and executable on the processor, wherein the processor, when executing the processor, implements the method according to any of the above.

Based on the same concept, this application further provides a non-transitory computer-readable storage medium, storing computer instructions for causing the computer to implement the method according to any of the above.

As seen from the above, the method, apparatus, electronic device and storage medium for document creation provided in this application include: displaying an adding panel in response to receiving a page adding operation in a first page of a table, the adding panel including a target document type, the target document type being a type other than a table; generating a second page in the table in response to a first selection operation on the target document type, the second page displaying a document corresponding to the target document type. According to this application, the adding creation option of the corresponding document is added in the adding directory of the first page of the table, the user may insert the document in the first page of the table by triggering the option, so that the document and the document editing tool are added in the first page and the table editing tool of the table. Thus, the text expression ability of the table is enriched, the representation pattern of the table editing tool is improved, the requirement of the user to add more text content to the table is met, and the user experience is improved.

### BRIEF DESCRIPTION OF THE DRAWINGS

In order to more clearly describe the technical solutions in the embodiments of this application or prior art, the accompanying drawings to be used in the description of the embodiments or prior art are briefly described below. Obviously, the drawings in the following description are merely embodiments of this application, and those of ordinary skill in the art may further obtain other drawings based on these drawings without creative work.

FIG. 1 is a schematic flowchart of a method of document creation according to an embodiment of this application;

FIG. 2 is a schematic diagram of displaying an adding panel on a first page according to an embodiment of this application;

FIG. 3 is a schematic diagram of displaying an adding panel and a template directory on a first page according to an embodiment of this application;

FIG. 4 is a schematic diagram of a generated second page according to an embodiment of this application;

FIG. 5 is a schematic diagram of a generated template library interface according to an embodiment of this application;

FIG. 6 is a schematic structural diagram of an apparatus for document creation according to an embodiment of this application; and

FIG. 7 is a schematic structural diagram of an electronic device according to an embodiment of this application.

### DETAILED DESCRIPTION

In order to make the objectives, technical solutions and advantages of the present specification clearer, the present specification is further described in detail below with reference to the accompanying drawings.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of this application. Other methods that satisfy relevant laws and regulations are also applicable to the implementations of this application.

It is to be understood that the data involved in this technical solution (including but not limited to the data itself, data acquisition, use, storage or deletion) should comply with the requirements of corresponding laws and regulations and relevant provisions.

In order to make the objectives, technical solutions and advantages of the present specification clearer, the present specification is further described in detail below with reference to the accompanying drawings.

It should be noted that, unless otherwise defined, technical terms or scientific terms used in the embodiments of this application should be of ordinary meanings understood by those skilled in the art to which this application belongs. The terms “first”, “second” and the like used in the embodiments of this application do not represent any order, quantity, or importance, but are merely used to distinguish different components. The term “comprise” or “include” or the like means that an element, object, or method step that appears in front of the term encompasses elements, objects, or method steps that appear behind the term and equivalents thereof, without excluding other elements, objects, or method steps. The term “connect” or “connected with/to” is not limited to physical or mechanical connections, but may include electrical connections, whether direct or indirect. “Upper”, “lower”, “left”, “right” and the like are only used to represent relative position relationships, and when the absolute position of the object to be described changes, the relative position relationship may also change accordingly.

As described in the background section, in the prior art, for common spreadsheets, e.g., an Excel table, after a user creates a new spreadsheet workbook, a blank table area is displayed in the screen, an editing column and a plurality of editing shortcut keys for editing the table are arranged beside the table area, and meanwhile, a tab corresponding to the table is further arranged in the table area. In the page, the user may perform editing to the table in various manners, and meanwhile, a new table page may be added and distinguished by a different tab. However, in the prior art, the editing interface of the spreadsheet only allows the increase or decrease of a table page. With the increase of user demands for table use, the user may need to insert a page document or the like in the spreadsheet. However, the current spreadsheet workbook may only add the form of the spreadsheet, which no longer meets the needs of the user. In addition, the representation pattern is rather single, and the user experience is poor.

In view of the foregoing actual situation, an embodiment of this application provides a document creation solution. According to this application, an adding creation option corresponding to a document is added in an adding directory of a first page of a table, and the user may insert the document in the first page of the table by triggering the option. Thus, the document and the document editing tool may be added in the first page and the table editing tool of the table, the text expression ability of the table is enriched, the overall representation pattern of the table editing tool is improved, the requirement of the user to add more text content to the table is met, and the user experience is improved.

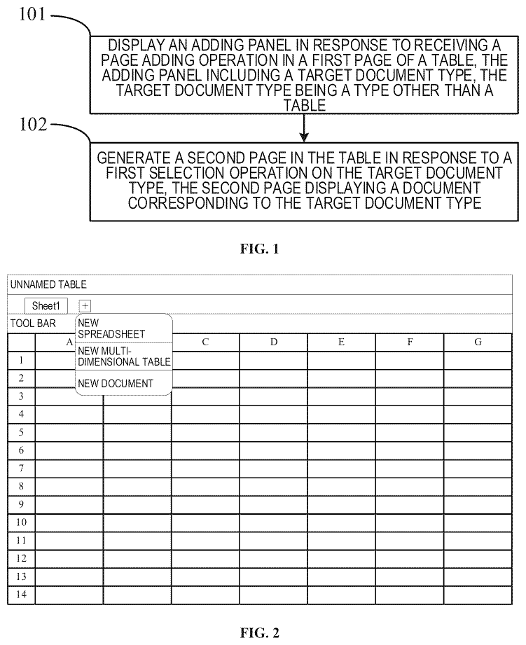

As shown in FIG. 1, this figure is a schematic flowchart of a method of document creation according to this application. The method specifically includes:
Step 101: displaying an adding panel in response to receiving a page adding operation in a first page of a table, wherein the adding panel includes a target document type, and the target document type is a type other than a table.

In some embodiments, the first page of the table is an interface for performing spreadsheet generation and content editing, e.g., an editing interface of Excel, and the like. In the page, in order to add a new table page, an option of adding a new page is generally set, and when the user selects the option, a new table is directly generated. In this embodiment, after the user selects the corresponding adding option, the user is considered to have performed the page adding operation. As shown in FIG. 2, an area where the “+” symbol is located is considered as the option of adding a new page, and after the user clicks the option, the user is considered to have performed a page adding operation on the first page. Of course, in some embodiments, the page adding operation may be triggered by double-click, moving, touch, gesture, etc., which may be specifically set according to a specific application scenario.

In some embodiments, after the user performs the page adding operation, the adding panel may pop up and be displayed, and the adding panel is a directory provided with a plurality of addable items, such as new spreadsheets, new multidimensional tables, and the like. By clicking on these options, the user may add a corresponding table to the table editing page. Specifically, the adding panel in this embodiment further includes a creation option of the target document type (as shown in FIG. 2), which provides the user with a function of inserting a page document into the first page of the table. Here, the target document type is another file type different from the table type, for example, a text editing type, a PPT editing type, or the like. Then, the appearing position of the adding panel may be any position in the first page, for example, on a side of the adding option, or generated in a position where the user performs an operation (for example, generated at a clicked position), and the like.
Step 102: generating a second page in the table in response to a first selection operation on the target document type, wherein the second page displays a document corresponding to the target document type.

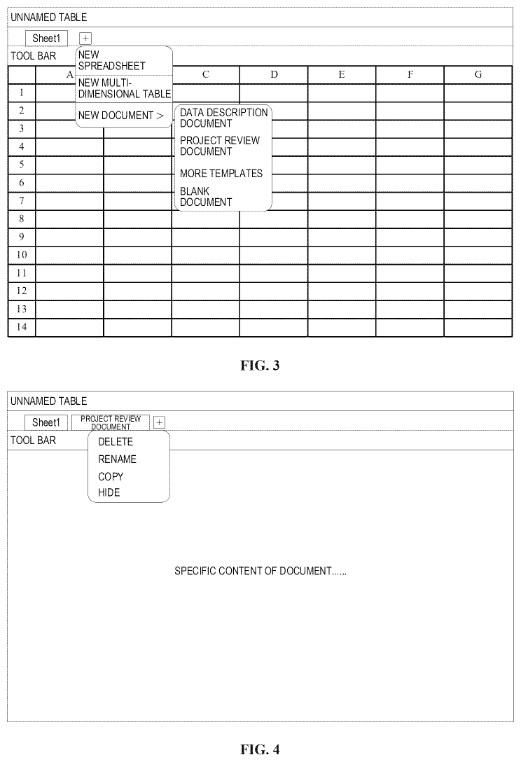

In some embodiments, after the user selects an option corresponding to the target document type in the adding panel (as shown in FIG. 2), a new document page may be generated in the table according to the selection operation, that is, the second page is generated, so that the user may perform document creation and editing in the new second page. Thus, the user may insert other types of document pages different from the table in the table editing software, and perform corresponding editing work through the page. As shown in FIG. 4, a new document page (second page) may be generated in the table editing software to edit the document, and the document page (the second page) may be distinguished from other table pages (the first page) through different tabs. Finally, an output operation may be performed for the entire table file containing the document page, which may be used to store, present, use or reprocess the table file containing the document page. The output manner of the table file may be flexibly selected according to different application scenarios and implementation requirements.

For example, for an application scenario in which the method in this embodiment is performed on a single device, the table file may be directly output on a display component (display, projector, etc.) of the current device in a display manner, so that an operator of the current device may directly see the content of the table file from the display component.

For another example, for an application scenario in which the method in this embodiment is performed on a system formed by a plurality of devices, the table file may be sent via any data communication method (wired connection, NFC, Bluetooth, Wi-Fi, cellular mobile network, etc.) to other preset devices in the system as receivers, i.e., synchronized terminals, so that the synchronized terminals may carry out subsequent processing thereon. Optionally, the synchronization terminal may be a preset server, and the server is generally disposed in the cloud as a data processing and storage center, which may store and distribute the table file. Receivers of the distribution are terminal devices, and a holder or operator of these terminal devices may be an owner of the table file, an editor of the table file, a reader of the table file, and the like.

For another example, for an application scenario in which the method in this embodiment is performed on a system formed by a plurality of devices, the table file may be directly sent to a preset terminal device via any data communication method, and the terminal device may be one or more of these listed in the foregoing paragraph.

In some embodiments, the first page and the second page may be tab pages in the table, for example, sheet1 and sheet2. The first page is a content page of the table architecture, the basic unit in the page is a cell, and the page content is a row and column table composed of cells; the second page is created in the form of a tag page, but the page content of the second page is the content of the non-table architecture, e.g., the content of the document, the second page is a blank page not taking the cell as a basic unit, and the user may freely edit the content in the page without being restricted by the cell.

As seen from the above, the method of document creation according to an embodiment of this application includes: displaying an adding panel in response to receiving a page adding operation in a first page of a table, the adding panel including a target document type, the target document type being a type other than a table; and generating a second page in the table in response to a first selection operation on the target document type, the second page displaying a document corresponding to the target document type. According to this application, the adding creation option corresponding to the document is added in the adding directory of the first page of the table, the user may insert the document in the first page of the table by triggering the option, so that the document and the document editing tool are added in the first page and the table editing tool of the table. Thus, the text expression ability of the table is enriched, the representation pattern of the table editing tool is improved, the requirement of the user to add more text content to the table is met, and the user experience is improved.

In some embodiments, before generating the second page in the table, the method includes: generating a template directory of the target document type; and generating, in response to a second selection operation on any option in the template directory, the second page corresponding to the selected option.

In some embodiments, the option in the adding panel may be provided with a second-level menu, as shown in FIG. 3. After the user performs the first selection operation on the target document type, the template directory (that is, the second-level menu of the target document type) may be further generated. The template directory is a directory of preset document representation templates, and the user may create documents of different representation forms by selecting options in the directory. As shown in FIG. 3, after the user selects a new document option, a new directory, namely a template directory, may pop up. In the directory, several common preset template options may be preset, such as a data description document, a project review document, and the like in FIG. 3. Then, in order to enable the user to select a desired specific template, a template library option (more template options shown in FIG. 3) may be set in the template directory. More templates may pop up for selection by the user when the user selects the option. Certainly, if the user wants to directly start the document editing and does not want to use the template, a blank template option (i.e., a blank document option in FIG. 3) may be set for the user, and after selecting this option, the user may start the document editing at the blank page without any template element. Then, according to the user's second selection operation on any option in the template directory, the second page corresponding to the option selected by the user may be generated.

In some embodiments, the generating the second page in the table includes: generating a corresponding page tab in the table according to name information of a selected template option, and generating the second page according to a document attribute corresponding to the selected template option.

In some embodiments, in order to distinguish between the pages, a corresponding page tab may be set for each page, and a page tab of the second page may be named according to a name of a template selected by the user so that the second page corresponding to the document may display the specific function of the page or reflect the specific content of the page. Then, in the page under the page tab, respective modules, fonts, page layouts and other attributes in the document page are set according to the document attribute corresponding to the template selected by the user. As shown in FIG. 4, the “Sheet1” tab may represent a previous spreadsheet page, i.e., the first page corresponding to an ordinary table page, and the project review document in the following “project review document” tab is name information corresponding to the template option selected by the user. After the user selects a page tab, a corresponding page may be jumped to.

In some embodiments, the document attribute includes: a document size attribute, a document component included in the document, and a setting attribute of the document component.

In some embodiments, the document size attribute is the length and width of the document. During document editing, generally, the overall length of the document is not limited, while the length of each page may be set according to a specific template requirement; the width may be limited since the paper, the display area, the editing area and the like are involved. The attributes corresponding to different templates may not be the same. Thereafter, the document component is each function block component for generating or setting a document, such as a normal text function block, an ordered list function block, an unordered list function block, a reference function block, a code block function block, a hyperlink function block, a picture function block, a video file function block, a web page function block, a flowchart function block, and the like, and a component for document editing, such as a toolbar, a shortcut, and the like. During template loading, corresponding components are set depending on whether these document components have or have not corresponding setting attributes. The setting attribute, for example, sets the position, size, displayed content or function of the corresponding component.

In some embodiments, the document size attribute follows a size attribute of the first page, wherein a width size of the document is not greater than a width of the first page.

In some embodiments, in order to facilitate the user to edit the document and manage the entire table file, the size such as the width of the document needs to follow the size attribute of the first page corresponding to the table and is made no greater than the width of the first page, to prevent the need for horizontal drag and drop of the page and other operations, which affects the aesthetics and makes it inconvenient for document management.

In some embodiments, after generating the second page according to the document attribute corresponding to the selected template option, the method further includes: displaying the second page in response to a third selection operation on the page tab; generating a management directory in response to a fourth selection operation on the page tab, and performing a management operation corresponding to the page tab and/or the second page according to a fifth selection operation on an option in the management directory.

In some embodiments, the third selection operation may be a left-click operation for the page tab, and the fourth selection operation may be a right-click operation for the page tab, the two selection operations being selection operations for different function keys of the page tab. After the user left-clicks on the page tab, the user may display or switch to the second page in the interface of the table software. After the user right-clicks the page tab, a management directory may be generated at the click position for performing corresponding management on the page tab and/or the corresponding document. The management directory may include a delete option, a rename option, a copy option, a hide option, and/or a move option. Deletion is the operation of deleting the page tab and the corresponding document, renaming is to rename the page tab, and copying, hiding and moving is the operation of copying, hiding and moving the page tab and the corresponding document.

In some embodiments, the template directory includes at least one preset template option, a template library option, and a blank template option.

In some embodiments, as shown in FIG. 3, several common preset template options may be preset in the template directory, such as the data description document, the project review document, and the like in FIG. 3. Then, in order to enable the user to select a desired specific template, a template library option (more template options shown in FIG. 3) may be set in the template directory, and when the user selects the option, more templates may pop up for the user to select. Of course, if the user wants to directly start the document editing and does not want to use the template, a blank template option (i.e., the blank document option in FIG. 3) may be set for the user, and after the user selects this option, the user may start to edit the document at the blank page without any template element.

In some embodiments, the in response to the second selection operation on any option in the template directory includes: generating a template library interface in response to the second selection operation on the template library option, and displaying all templates in the template library through the template library interface.

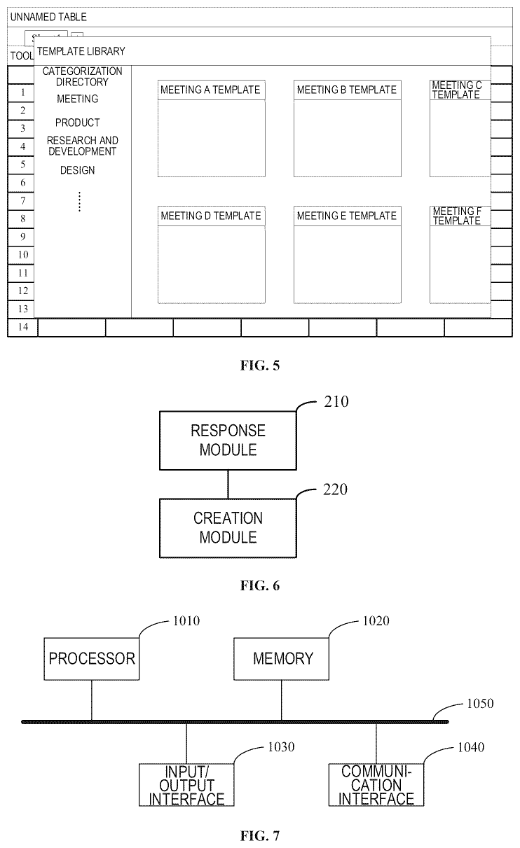

In some embodiments, as shown in FIG. 5, after the user selects the template library option, a template library interface may be newly generated in the interface of the current table, and the template library interface may include all templates recorded in the template library. Of course, in order to facilitate display, sliding may be performed in the template library interface by drag and drop and the like, to display different templates.

In some embodiments, the displaying all templates in the template library through the template library interface includes: classifying all the templates according to attributes thereof, and displaying all the templates in categories in the template library interface.

In some embodiments, in order to better manage templates in the template library interface and facilitate the user to query a template, templates in the template library may be classified according to their corresponding main attributes. For example, some templates are for data statistics, some templates are for conference minutes, some templates are for content presentation, and so on. The templates are classified according to the main attributes of each template, and displayed in categories in the template library interface, so as to facilitate the query and management of the user.

In some embodiments, after generating the second page in the table, the method further includes: in response to a disposition operation on the table, performing the corresponding disposition operation on the second page and a document in the second page.

In some embodiments, since the second page itself is a page in the table file, it is a part of the table file in essence. When the user performs a corresponding disposition operation on the table or the entire table file, the document is disposed together with the table or the entire table file. The disposed operation herein is deletion, recovery and/or complete deletion of the table or the entire table file. In some embodiments, the disposition operation may also be copying, hiding and the like of the table or the entire table file.

In some embodiments, generating the second page in the table includes: the permission of the second page following the permission setting of the table.

In some embodiments, like the previous embodiment, the second page itself is a page in the table file, and the use permission of the second page and the document in the second page generally also follows the permission setting of the table. The permission herein refers to the document's ownership, read permission, edit permission, copy, copy creation, print, download permission, comment permission, etc. These document permissions naturally follow the table file. Of course, in some embodiments, after the owner of the document or the table file separately sets the permission, the document or the second page may be limited according to the set permission.

It should be noted that the method in the embodiments of this application may be performed by a single device, for example, a computer or a server. The method in the embodiments of this application may also be applied to a distributed scenario and is completed through cooperation between a plurality of devices. In this distributed scenario, one of the plurality of devices may perform only one or more steps in the method in the embodiments of this application, and the plurality of devices interact with each other to complete the method.

It should be noted that the foregoing describes specific embodiments of this application. Other embodiments are within the scope of the appended claims. In some cases, the acts or steps recited in the claims may be performed in a different order than in the above embodiments and still achieve the desired results. Additionally, the processes depicted in the figures do not necessarily require a particular order or sequential order shown to achieve the desired results. In certain implementations, multitasking and parallel processing are also possible or may be advantageous.

Based on the same concept, corresponding to the foregoing embodiment methods, this application further provides an apparatus for document creation.

Referring to FIG. 6, the apparatus for document creation includes:
a response module 210 configured to display an adding panel in response to receiving a page adding operation in a first page of a table, the adding panel including a target document type, the target document type being a type other than a table; and
a creation module 220 configured to generate a second page in the table in response to a first selection operation on the target document type, the second page displaying a document corresponding to the target document type.

For convenience of description, the modules are described separately according to functions in describing the foregoing apparatus. Of course, when implementing the embodiments of this application, functions of the modules may be implemented in one or more software and/or hardware.

The apparatus of the foregoing embodiment is configured to implement the corresponding method of document creation in the foregoing embodiments, and has the beneficial effects of the corresponding method embodiments, which is not repeated herein again.

In some embodiments, the creation module 220 is further configured to:
generate a template directory of the target document type; and
in response to a second selection operation on any option in the template directory, generate the second page corresponding to the selected option.

In some embodiments, the creation module 220 is further configured to:
generate a corresponding page tab in the table according to name information of a selected template option, and generate the second page according to a document attribute corresponding to the selected template option.

In some embodiments, the document attribute includes: a document size attribute, a document component included in the document, and a setting attribute of the document component.

In some embodiments, the document size attribute follows a size attribute of the first page, and a width size is not greater than a width of the first page.

In some embodiments, the creation module 220 is further configured to:
display the second page in response to a third selection operation on the page tab;
generate a management directory in response to a fourth selection operation on the page tab, and perform a corresponding management operation on the page tab and/or the second page according to a fifth selection operation on an option in a management directory.

In some embodiments, the management directory includes: a delete option, a rename option, a copy option, a hide option, and/or a move option.

In some embodiments, the template directory includes: at least one preset template option, a template library option, and a blank template option.

In some embodiments, the creation module 220 is further configured to:
in response to the second selection operation on the template library option, generate a template library interface so as to display all templates in a template library through the template library interface.

In some embodiments, the creation module 220 is further configured to:
classify all the templates according to attributes thereof, and display all the templates in categories in the template library interface.

In some embodiments, the creation module 220 is further configured to:
in response to a disposition operation on the table, perform the corresponding disposition operation on the second page and a document in the second page.

In some embodiments, the disposition operation includes deletion, recovery, and/or complete deletion.

In some embodiments, the creation module 220 is further configured to:
make the permission of the second page follow the permission setting of the table.

Based on the same concept, corresponding to any of the foregoing embodiment methods, this application further provides an electronic device, including a memory, a processor, and a computer program stored in the memory and executable on the processor, wherein the processor, when executing the program, implements the method of document creation according to any one of the foregoing embodiments.

FIG. 7 is a schematic structural diagram of a more specific hardware structure of an electronic device according to this embodiment. The device may include: a processor 1010, a memory 1020, an input/output interface 1030, a communications interface 1040, and a bus 1050. The processor 1010, the memory 1020, the input/output interface 1030, and the communications interface 1040 implement, via the bus 1050, a communication connection with each other inside the device.

The processor 1010 may be implemented by using a general-purpose central processing unit (CPU), a microprocessor, an application specific integrated circuit (ASIC), or one or more integrated circuits, and is configured to execute related programs to implement the technical solutions provided in the embodiments of the present specification.

The memory 1020 may be implemented in a form of a ROM (Read Only Memory), a Random Access Memory (RAM), a static storage device, a dynamic storage device, or the like. The memory 1020 may store an operating system and other applications, and when implementing the technical solutions provided in the embodiments of the present specification by using software or firmware, related program code is stored in the memory 1020 and invoked and executed by the processor 1010.

The input/output interface 1030 is configured to connect the input/output module to implement information input and output. The input/output module may be configured as a component (not shown in the figure) in the device, or may be externally connected to the device to provide a corresponding function. The input device may include a keyboard, a mouse, a touch screen, a microphone, various sensors, etc., and the output device may include a display, a speaker, a vibrator, an indicator light, and the like.

The communications interface 1040 is configured to connect a communications module (not shown in the figure) so as to implement communications interaction between the device and another device. The communications module may implement communications in a wired manner (for example, a USB or a network cable), or may implement communications in a wireless manner (for example, a mobile network, a Wi-Fi, a Bluetooth, and the like).

The bus 1050 includes a path to transfer information between various components of the device (such as the processor 1010, the memory 1020, the input/output interface 1030, and the communication interface 1040).

It should be noted that although the foregoing device only shows the processor 1010, the memory 1020, the input/output interface 1030, the communications interface 1040, and the bus 1050, in a specific implementation process, the device may further include other components necessary for normal running. In addition, those skilled in the art may understand that the foregoing device may also include only components necessary for implementing the solutions in the embodiments of the present specification, rather than necessarily including all components shown in the figure.

The electronic device of the foregoing embodiment is configured to implement the corresponding method of document creation in any one of the foregoing embodiments, and has the beneficial effects of the corresponding method embodiments, which is not repeated herein.

Based on the same concept, corresponding to any of the foregoing embodiment methods, this application further provides a non-transitory computer-readable storage medium storing computer instructions for causing the computer to perform the method of document creation according to any of the foregoing embodiments.

Computer-readable media of the present embodiment include permanent and non-permanent, removable and non-removable media, which may be implemented by any method or technology. The information may be computer readable instructions, data structures, modules of a program, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disc read-only memory (CD-ROM), digital versatile disc (DVD) or other optical storage, magnetic cassettes, magnetic tape disk storage or other magnetic storage devices, or any other non-transmission medium, which can be used to store information accessible by a computing device.

The computer instructions stored in the storage medium in the foregoing embodiments are configured to cause the computer to perform the method of document creation according to any of the foregoing embodiments, and have the beneficial effects of the corresponding method embodiments, which is not repeated herein.

Those of ordinary skill in the art should understand that the foregoing discussion of any embodiment is merely illustrative, and is not intended to suggest that the scope of the present application (including the claims) is limited to these examples; in the spirit of this application, the above embodiments or the technical features in different embodiments may also be combined, and the steps may be implemented in any order, and there are many other changes in different aspects of the embodiments of this application as described above, which is not provided in details for the sake of brevity.

Additionally, for simplicity of illustration and discussion, and to not obscure the embodiments of the present application, well-known power/ground connections to integrated circuit (IC) chips and other components may or may not be shown in the figures provided. Furthermore, the apparatus may be shown in a block diagram in order to avoid obscuring the embodiments of the present application, and this also takes into account the fact that the details regarding the implementation of these block diagram devices are highly dependent on the platform in which the embodiments of the present application are to be implemented (i.e., these details should be fully within the understanding of those skilled in the art). Having set forth specific details (e.g., circuits) to describe example embodiments of the present application, it will be apparent to those skilled in the art that the embodiments of the present application may be implemented without these specific details or with changes to these specific details. Accordingly, these descriptions should be considered illustrative and not limiting.

Although the present application has been described in conjunction with specific embodiments of the present application, many replacements, modifications and variations of these embodiments will be apparent to those of ordinary skill in the art from the foregoing description. For example, other memory architectures (e.g., dynamic RAM (DRAM)) may use the embodiments discussed.

This application is intended to cover all such replacements, modifications and variations that fall within the broad scope of the appended claims. Therefore, any omission, modification, equivalent replacement, improvement and the like that are made within the spirit and principle of the embodiments of this application should be included within the protection scope of this application.

1. A method of document creation, comprising:
displaying an adding panel in response to receiving a page adding operation in a first page of a table, the adding panel comprising a target document type, the target document type being a type other than a table;
generating a second page in the table in response to a first selection operation on the target document type, the second page displaying a document corresponding to the target document type.

2. The method of claim 1, wherein before generating the second page in the table, the method further comprises:
generating a template directory of the target document type; and
in response to a second selection operation on any option in the template directory, generating the second page corresponding to the selected option.

3. The method of claim 2, wherein generating the second page in the table comprises:
generating a corresponding page tab in the table according to name information of a selected template option, and generating the second page according to a document attribute corresponding to the selected template option.

4. The method of claim 3, wherein the document attribute comprises: a document size attribute, a document component comprised in the document, and a setting attribute of the document component.

5. The method of claim 4, wherein the document size attribute follows a size attribute of the first page, and a width size is not greater than a width of the first page.

6. The method of claim 5, wherein after generating the second page according to the document attribute corresponding to the selected template option, the method further comprises:
displaying the second page in response to a third selection operation on the page tab;
generating a management directory in response to a fourth selection operation on the page tab, and performing a corresponding management operation on the page tab and/or the second page according to a fifth selection operation on an option in a management directory.

7. The method of claim 6, wherein the management directory comprises: a delete option, a rename option, a copy option, a hide option, and/or a move option.

8. The method of claim 2, wherein the template directory comprises: at least one preset template option, a template library option, and a blank template option.

9. The method of claim 8, wherein in response to the second selection operation on any option in the template directory comprises:
in response to the second selection operation on the template library option, generating a template library interface to display all templates in a template library through the template library interface.

10. The method of claim 9, wherein displaying all the templates in the template library through the template library interface comprises:
classifying all the templates according to attributes of all the templates, and displaying all the classified templates in the template library interface.

11. The method of claim 1, wherein after generating the second page in the table, the method further comprises:
in response to a disposition operation on the table, performing a corresponding disposition operation on the second page and a document in the second page.

12. The method of claim 11, wherein the disposition operation comprises: deletion, recovery, and/or complete deletion.

13. The method of claim 1, wherein generating the second page in the table comprises:
a permission of the second page following a permission setting of the table.

14. (canceled)

15. An electronic device, comprising: a memory, a processor, and a computer program stored in the memory and executable on the processor, wherein the processor, when executing the program, implements acts comprising:
displaying an adding panel in response to receiving a page adding operation in a first page of a table, the adding panel comprising a target document type, the target document type being a type other than a table;
generating a second page in the table in response to a first selection operation on the target document type, the second page displaying a document corresponding to the target document type.

16. (canceled)

17. The electronic device of claim 15, wherein before generating the second page in the table, the acts further comprise:
generating a template directory of the target document type; and
in response to a second selection operation on any option in the template directory, generating the second page corresponding to the selected option.

18. The electronic device of claim 17, wherein generating the second page in the table comprises:
generating a corresponding page tab in the table according to name information of a selected template option, and generating the second page according to a document attribute corresponding to the selected template option.

19. The electronic device of claim 18, wherein the document attribute comprises: a document size attribute, a document component comprised in the document, and a setting attribute of the document component.

20. A non-transitory computer-readable storage medium, storing computer instructions for causing the computer to implement acts comprising:
displaying an adding panel in response to receiving a page adding operation in a first page of a table, the adding panel comprising a target document type, the target document type being a type other than a table;
generating a second page in the table in response to a first selection operation on the target document type, the second page displaying a document corresponding to the target document type.

21. The non-transitory computer-readable storage medium of claim 20, wherein before generating the second page in the table, the acts further comprise:
generating a template directory of the target document type; and
in response to a second selection operation on any option in the template directory, generating the second page corresponding to the selected option.

22. The non-transitory computer-readable storage medium of claim 21, wherein generating the second page in the table comprises:
generating a corresponding page tab in the table according to name information of a selected template option, and generating the second page according to a document attribute corresponding to the selected template option.
